(19) United States
(12) Patent Application Publication
(10) Pub. No.: US 2021/0203231 A1
(43) Pub. Date: Jul. 1, 2021

(54) LOW-POWER MODE FOR POWER SUPPLY WITH TWO-STAGE DRIVER

(71) Applicant: Viza Electronics Pte. Ltd., Charlotte, NC (US)

(72) Inventors: Jack Lula, Burlington (CA); Robert Zamora, Huntersville, NC (US)

(21) Appl. No.: 17/139,887

(22) Filed: Dec. 31, 2020

Related U.S. Application Data
(60) Provisional application No. 62/955,992, filed on Dec. 31, 2019.

(51) Int. Cl. H02M 3/158; H02M 3/335; H02M 1/08

(52) U.S. Cl. CPC H02M 3/158; H02M 1/08; H02M 3/33546

(57) ABSTRACT

A power supply with first and second stage outputs includes a low-power mode that enables continuous operation at increased power efficiency. A flyback converter is driven by a flyback controller that has a reference input. A voltage divider at the reference input sets a reference voltage for operation of the flyback controller. A low-power-mode circuit may include a switch that modifies the voltage divider depending on a selected power mode. In low-power mode, the reference voltage is increased, causing the output voltage of the flyback converter to decrease. At least a DC-DC converter as part of the second stage output may operate more efficiently when powered at the decreased voltage in the low-power mode, while loads on the first stage output requiring higher voltage are powered off.

### CROSS REFERENCE TO RELATED APPLICATION

This application claims the benefit of priority of U.S. Provisional Application No. 62/955,992, entitled “Low-Power Mode for Two-Stage Driver,” filed Dec. 31, 2019, which is expressly incorporated herein by reference in its entirety.

### BACKGROUND

Commercial regulations increasingly require that electronic devices consume lower amounts of power. These regulations arise for many reasons, including green initiatives to avoid generating and consuming unnecessary electrical energy. As a result, modern electrical devices must be highly efficient with their use of electrical power.

Low-power mode or standby mode for electrical devices are often leading areas of restrictive regulation. Although the two modes are generally within the same subject, low-power mode may refer to an operating condition for a device that draws a relatively small amount of electrical power, such as when many, but not all, functions of the device are inactive. Standby mode may refer to a condition in which the electrical device is no longer operating at all and yet still draws small amounts of electricity while waiting to be activated. Standby power has also been called vampire power or other terms due to its tendency to drain electricity while the device is essentially turned off.

In these modes, the electrical device is typically not operating in its normal capacity. Yet the device must still have a continuous, or near continuous, source of power to remain functional or to return to normal functionality quickly. For example, a smart appliance, such as a smart light, may include a WiFi connection that must remain in operation despite the appliance being in the off-state, i.e., the light source being off. As a result, the smart light may be viewed as being in a low-power mode while the light source is inactive.

EnergyStar, which is a leading regulation of the U.S. government, currently specifies that standby or low-power mode of an electronic device such as a single-board computer must be under 500 milliwatts of AC power. A device drawing higher power when in standby or low-power mode will not obtain certification and could be subject to a recall. In the future, this ceiling for minimal power is expected to be set even lower. Other government regulations, such as those from states, can set different and possibly lower requirements.

For supplying low-voltage electronics with DC power, modern electronics often employ a power supply or controller using a flyback converter with a flyback controller. Input power may come from AC mains power, such as at 120/277 volts, which is rectified to a DC input voltage. The DC input is provided to a transformer of the flyback converter, which is coupled to the flyback controller for regulating the output voltage. The output of the transformer provides a first output voltage at a predetermined level of DC volts. A second output stage of DC voltage may also be provided from the transformer output by including a DC-DC controller to generate a second DC voltage at a lower level. In some situations, the first output voltage may provide power only for a normal operating mode for an electronic device or system, while the second output voltage may provide the lower voltage continuously, or at least for a low-power or standby operating mode for the device or system.

Meeting regulations for low power consumption can be particularly challenging when considering the power draw of both the electronic apparatus being driven and the power supply itself. U.S. Pat. No. 10,275,780 addresses one scheme for lowering power consumption by a power supply when in a standby mode for driving LED lights in a dim-to-off mode. A transistor is provided between the rectified DC power and the voltage Vcc of a flyback controller and configured to be switched on or off by the flyback controller to selectively provide a power supply input voltage to the flyback controller chip. In essence, power consumption of the flyback controller chip is reduced to a minimum level required to keep an LED switch alive so that it can respond to a wake-up signal from a remote user.

Other approaches to lowering power consumption often involve implementing a whole separate path to power the portions of the circuit requiring the lowest power. That is, one output stage that may require high power in normal operation, such as a bank of LEDs, is driven by a single power path from the AC mains, while a second output stage that functions alone in a low-power mode, such as a radio to provide constant communications to a WiFi network, is driven by a separate power path from the AC mains source. While providing low power consumption for separate modes of operating, these approaches are more complex and expensive.

A need exists for a single power supply having a two-stage driver for electronic devices that can provide high power efficiency when operating in a low-power mode. The single power supply needs to provide high efficiency with a simple and low-cost implementation suitable for mass production.

### BRIEF DESCRIPTION OF THE DRAWINGS

The detailed description is described with reference to the accompanying FIGURES. The same reference numbers in different FIGURES indicate similar or identical items.

FIG. 1 is a general schematic diagram of a power supply with a two-stage driver for an electronic device with a low-power mode consistent with an example of the disclosure.

### DESCRIPTION

The following detailed description is directed to technologies for providing high electrical power efficiency for a switched power supply operating in a low-power mode. The low-power mode may coincide with powering a smart energy device that, while its primary functions are disabled, remains connected to communications networks such as WiFi for receiving communications. More particularly, the description identifies circuitry for adjusting performance of a flyback controller in a switched power supply to reduce current draw by a DC-DC controller in an output stage and improving overall power efficiency for the power supply.

The circuitry of this disclosure provides a single power control path for driving electronics in a normal or high-power mode (stage one) and electronics that function in both the high-power mode and in a low-power mode (stage two). A flyback controller and a transformer within a flyback converter provide a stable high voltage level at the output for powering the stage-one and stage-two loads in the normal mode at stage one. When the high voltage level is no longer needed because the loads have entered a low-power mode, a signal commands the power supply to switch into a low-power mode. That signal trips a switch within the power supply that adds or removes a resistor as part of a resistor network in a voltage divider, causing a voltage at an input to a flyback controller to change.

The changed voltage on the flyback controller causes the flyback controller to lower its operating voltage, and hence lower its operating power, and to lower the output voltage from the transformer of the flyback converter. The DC-DC controller supplying the electronics in the low-power mode is powered by the output voltage from the transformer. The DC-DC controller can continue to supply approximately the same output voltage to its load in the low-power mode, and the DC-DC controller enters a higher stage of efficiency caused by the lower ratio of its input:output voltages. This higher stage of efficiency can yield small, yet significant savings in power consumption in a low-power state. Additional circuitry needed for implementing the concepts of this disclosure could be as few as a resistor and a MOSFET switch, although implementation details remain within the discretion of a person of ordinary skill in the art.

Following principles of this disclosure, examples of a power supply may include a flyback converter with a transformer having a primary side and secondary side and a first switch coupled between the primary side of the transformer and ground. A flyback controller may have a control input coupled to at least a first resistor and an output coupled to the primary side of the transformer through the first switch. The power supply may include a low-power-mode circuit having a second resistor connected in parallel with the first resistor and in series with a second switch. In a low-power mode of the power supply, the second switch is configured to be either open or closed in response to a control signal to activate the low-power mode.

The exemplary power supply may have two output stages. A first-stage output may be coupled to the secondary side of the transformer for powering a first external circuit in a high-power mode of the power supply. A second-stage output may be coupled to the secondary side of the transformer through a DC-DC converter for powering a second external circuit in at least the low-power mode of the power supply.

In various forms described further herein, the first resistor and the second resistor may be part of a voltage divider selectively modified by the second switch. An input to the second switch may be indicative of the low-power mode or the high-power mode for the power supply and when the second switch is activated, the low-power-mode circuit causes a voltage at the control input to increase. Changing the voltage at the control input, in turn, causes an output voltage on the secondary side of the transformer to decrease and yet to remain above an operating voltage of the DC-DC converter. In certain examples, the output voltage on the secondary side of the transformer is decreased from about 40V to about 20-30V when the second switch is closed.

In further examples of the disclosure, a method may include applying a low-power mode to a switched power supply. In particular, an exemplary method may generally entail providing, within a flyback converter, a DC input voltage to a primary side of a transformer, generating an output signal from a flyback controller at least in part in response to a voltage at an input pin of the flyback controller, and modifying a first flow of current through the primary side of the transformer at least in part in response to the output signal from the flyback controller. The method may include directing a DC output voltage from a secondary side of the transformer to a first-stage load and converting, with a DC-DC converter, the DC output voltage to a lower DC output voltage for a second-stage load.

As well, operating the power supply may involve receiving activation of a low-power-mode signal. At least in part in response to the activation of the low-power-mode signal, the DC output voltage may be caused to decrease to a low-power-mode DC output voltage. The voltage decrease may occur at least by changing the voltage at the input pin of the flyback controller while continuing to generate the output signal from the flyback controller. Changing the voltage at the input pin may entail modifying a voltage divider coupled to the input pin. Modifying the voltage divider may occur by closing a switch to complete a circuit to couple a resistor to the input pin.

Conversely, operating the power supply may include receiving a deactivation of the low-power-mode signal, indicating a shift from low-power mode back to high-power mode. At least in part in response to the deactivation, the voltage at the input pin of the flyback controller may be changed such that the voltage causes the low-power-mode DC output voltage to increase to the DC output voltage. Changing the voltage at the input pin of the flyback controller may involve opening the switch to disconnect from ground the resistor coupled to the input pin.

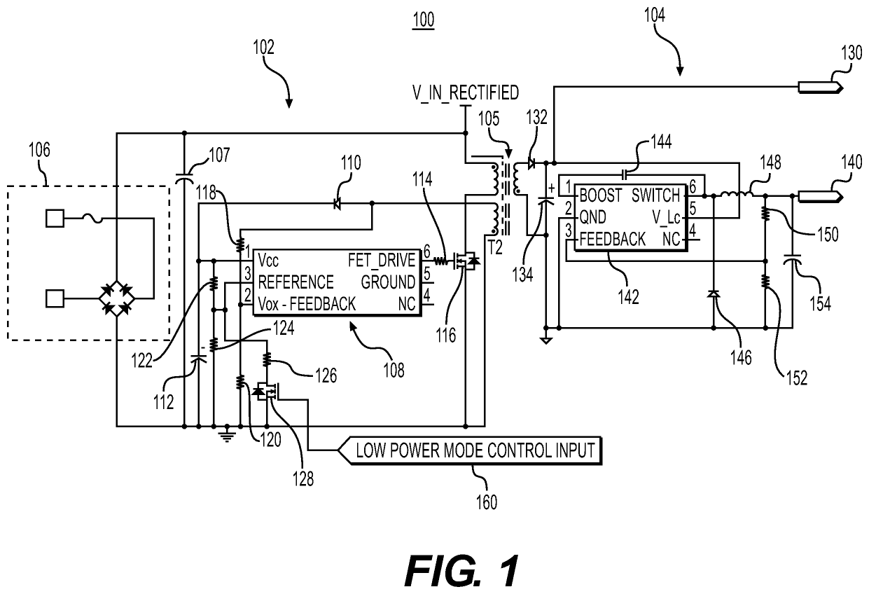

FIG. 1 depicts a general schematic diagram of a circuit for achieving high power efficiency in a low-power mode that may be activated on demand. Power supply with two-stage driver 100 in FIG. 1 essentially contains a switched power supply having power-input side 102 and power-output side 104 separated by transformer 105.

Power-input side 102 includes a source of DC input voltage. The DC input voltage most commonly is derived from AC mains power, such as 120/277 volts AC power. Rectifier circuit 106 converts the AC voltage to a rectified AC voltage, or DC input voltage, which is denoted as V_IN_RECTIFIED in FIG. 1. The value of V_IN_RECTIFIED naturally depends on the value of the AC mains power, but could be in the range of 150-500 volts DC. A capacitor 107 may be provided between the output of rectifier 106 and ground. Alternatively, DC input voltage may be received directly rather than rectified from an AC supply voltage.

Transformer 105 provides electrical isolation between its primary and secondary sides and provides an adjusted voltage value to its secondary side in a conventional manner. Transformer 105 and capacitor 107 together with affiliated components described further below, such as switch 116, diode 132, and capacitor 134, may operate as a flyback converter for power supply 100.

Coupled to transformer 105 is a flyback controller 108 arranged in configuration of primary feedback. In general, flyback controller 108 receives input voltage signals as further described and generates an output signal used for controlling the passage of current through the primary side of transformer 105. Flyback controller chips are available from many suppliers in multiple variations, and selection of a suitable option is within the knowledge of those skilled in the art. Models such as iW3627 from Dialog Semiconductor may provide acceptable functionality consistent with the circuit of FIG. 1.

Arranged with flyback controller 108 is a diode 110 between a primary winding of transformer 105 and Vcc input to flyback controller 108. As well, a capacitor 112 is coupled from Vcc of flyback controller 108 to ground. This circuitry provides the operating voltage for the flyback controller and is approximately a fixed ratio of the flyback secondary output voltage.

Flyback controller 108 includes inputs at a Reference pin and a Volt-Feedback pin. Both inputs have voltage dividers at their inputs. For the Volt-Feedback pin, a voltage divider is formed by resistors 118 and 120 between the primary side of transformer 105 and ground. For the Reference pin, a voltage divider is formed by resistors 122 and 124 between Vcc input to flyback controller 108 and ground.

At a FET_Drive pin, flyback controller 108 provides an output signal for controlling operation of the circuit components functioning as a flyback converter. The output signal at FET_Drive pin is generated as a function of the input voltage levels on pins Vcc, Reference, and Volt-Feedback in a known manner. Connected to FET_Drive pin is a resistor 114 and a switch 116, such as a MOSFET or similar electronic device, between a primary winding of transformer 105 and ground. As a result, the output signal from FET_Drive pin on flyback controller 108 is used to control the flow of current through transformer 105. The designation of input pins as Reference and Volt-Feedback and output pin as FET_Drive are arbitrary and may be different for other flyback controllers selected for implementing the disclosed concepts.

Operation of flyback controller 108 consistent with the principles of this disclosure follows from the arrangement of the voltage dividers on one or both of pins Reference and Volt-Feedback on flyback controller 108. Either of the voltage dividers may be modified to adjust the output voltage of the flyback converter. As shown in FIG. 1, in one embodiment, the voltage divider at the Reference pin may be selectively modified by adding a resistor 126 to the resistor network formed by resistor 122 and resistor 124. A switch 128, such as a MOSFET or similar electronic device, is coupled to resistor 126. As discussed further below, an input signal designated as Low Power Mode Control Input 160 is provided to MOSFET 128 to control its switching operation and to include or exclude resistor 126 from the voltage divider at the Reference pin. Although not shown, resistor 126 and switch 128 could additionally or alternatively be located in parallel with resistor 122 rather than resistor 124. As well, resistor and switch 128 could be located in parallel with either of resistors 118 and 120 that form a voltage divider for Volt-Feedback pin on controller 108.

On the power-output side of circuit 100, two output stages are provided. As mentioned above, diode 132 and capacitor 134 on the secondary side of transformer 105 serve as the output end of a flyback converter. A first or primary stage output 130 of power supply 100 is fed from diode 132 and capacitor 134. Primary stage output 130 is typically connected to a first external circuit (not shown) that operates in a normal or high-power mode for the system, such as bank of LEDs that draws power when illuminated. As an example, primary stage output 130 may provide 40V DC at 0.5 A for normal operation. Although included for completeness in this disclosure, primary stage output 130 is optional for carrying out the principles of a low-power mode as disclosed herein.

A second or secondary stage output 140 in FIG. 1 is coupled to a second external circuit that operates in a low-power mode for the system. The second external circuit may operate continuously, such as in the case of a radio connected to a communications network in a smart appliance. Voltage and current for the secondary stage output 140 is provided by a DC-DC controller 142.

DC-DC controller chips are available from many suppliers in multiple variations, and selection of a suitable option is within the knowledge of those skilled in the art. Models such as MP2459 from Monolithic Power Systems may provide acceptable functionality consistent with the circuit of FIG. 1. In this embodiment, the circuit including DC-DC controller 142 is a buck regulator, but this portion of the circuit could be a boost regulator or any other DC-DC regulator where the conversion efficiency of the circuit in low-power operating mode is consistent with the present disclosure.

An output of diode 132 from transformer 105 is fed to input V_IN pin of DC-DC controller chip 142. A Switch output of chip 142 includes capacitor 144 connected to a Boost pin of the chip 142. As well, a zener diode 146 connects Boost pin to ground, and an inductor 148 and capacitor 154 are provided between Boost pin and the secondary stage output 140 to the second external circuit (not shown). A network of resistor 150 and resistor 152 are provided to a Feedback pin of controller chip 142. The designation of pins as Boost, Feedback, Switch, and V_IN are arbitrary and may be different for other DC-DC controllers selected for implementing the disclosed concepts.

The circuit of FIG. 1 can operate in a first mode to provide two output voltage stages in normal operation, otherwise termed a normal mode or a high-power mode. In this first mode, the Low Power Mode Control Input 160 is not activated (switch closed), and the flyback controller functions in a manner such that about 40V DC at 0.5 A is provided to primary stage output 130 and about 12V DC at 0.5 A is generated for secondary stage output 140. In this high-power mode, switch 128 is kept closed, such that current flows through resistor 126 to ground. As a result, resistor 126 forms part of the network of resistors 122 and 124, which act as a voltage divider at the Reference pin on flyback controller 108.

In a second mode for low-power operation, the circuitry affiliated with the first external circuit (not shown) at primary stage output 130 does not require power. For instance, bank of LEDs or other electrical device otherwise using the 40V at 0.5 A is turned off. The signal Low Power Mode Control Input 160 may be generated by any known means, such as an electronic control system, a remotely derived signal, or user activation. Low Power Mode Control Input 160, when activated either as a logic HIGH or logic LOW level, indicates that the loads for the power supply no longer require the higher voltage and current draws for primary stage output 130 and that power supply 100 should change to an operational mode requiring less power for its components (independent of a requirement for less power for the load at secondary stage output 140).

When Low Power Mode Control Input 160 is activated, switch 128 is opened, which causes resistor 126 to be disconnected from ground. As a result, resistor 126 is no longer part of the network of resistors 122 and 124 and does not contribute to the voltage divider at the Reference pin on flyback controller 108. In this condition, the voltage at the Reference pin on flyback controller 108 is changed by the new resistor network formed only by resistors 122 and 124.

In more detail, in a normal operating mode, the voltage at the Reference pin on flyback controller 108 causes the flyback controller to regulate its voltage and the output voltage through transformer 105 using FET_Drive line on the flyback controller 108. Based on chosen values for the resistors, transformer 105 and other components, that output at primary stage output 130 (and at the input V_IN to DC-DC controller 142) may be around 40V DC at 0.5 A in some examples. DC-DC controller 142 may in turn, depending on chosen values for the resistors and other components, produce an output at secondary stage output 140 of around 12V DC at 0.5 A in some examples. When switch 128 is opened and resistor 126 is disconnected from ground, the voltage at the Reference pin (the junction of resistors 122 and 124) will increase, and flyback controller 108 will change its behavior to regulate the output voltage. The result will be a decrease in output voltage from the flyback converter, preferably in some implementations from around 40V to around 20-30V.

In normal or high-power mode, the flyback controller is intended to be operated generally at about 12-14V for its Vcc to optimize the internal requirements of the component and the external power requirements to drive MOSFET 116. In low-power mode, the Vcc of the flyback controller 108 in some examples may be operated at 6.5V to reduce quiescent circuit power requirements. Flyback controller 108 may still function acceptably for the purposes of FIG. 1 at this reduced Vcc.

While the change in output voltage from transformer 105 caused by activating Low Power Mode Control Input 160 will decrease the output voltage from the flyback converter used to power DC-DC controller 142, this low-power DC output voltage will not appreciably affect the output voltage of DC-DC controller 142. That is, although DC-DC controller 142 may be intended to operate with a power source at V_IN at about 40V in some examples to provide an output of about 12V, it may continue to provide a consistent voltage output of around 12V when the component is powered at 20-30V.

Moreover, when operating at a lower V_IN in the range of 20-30V, controller 142 will begin operating at a higher efficiency. With most DC-DC controllers, power efficiency is related to the difference between the input and output voltages. Generally, the larger the difference between the input and output voltages, the worse the efficiency. Thus, DC-DC controller 142 operates at a lower efficiency at high input voltages, such as the 40V under a normal operation for circuit 100, than it does at lower input voltages, such as the 20-30V under a low-power operation selected by signal Low Power Mode Control Input 160.

Flyback controller 108 may also operate at a higher efficiency in the low-power mode due to circuit 100 functioning at lower voltages. The combination of the increased efficiencies for chips 108 and 142 can provide a drop in current draw for low-power mode for power supply 100, which can lead to a significant decrease in power usage as a percentage.

As discussed, an example of a normal or high-power mode may provide the following results: First Stage Output: 40V at 0.5 A; Second Stage Output: 12V at 0.5 A. This mode would be indicative of an application, such as an LED light with an auxiliary function, where when operating in full capacity, the first stage output is powering the LEDs, and the second stage output is powering an accessory such as a camera system that is transmitting live imagery.

An example of a low-power mode may provide the following results: First Stage Output: 0.0 A; Second Stage Output: 12V at 0.025 A. When the device is requested to enter low-power mode, either by intelligent circuitry, a sensor activation, or even a manual input, the power requirements change significantly. Continuing the example from above, the LEDs are turned off, hence there is no power requirement for the first stage output connection. For this reason, the second stage output voltage can be modified to optimize the power requirements of the second stage output which is now 0.025 A, which could be indicative of an always-on radio used for control. Other values for the two stages are within the scope of the present disclosure and can vary with a different selection of components for circuit 100.

In certain embodiments of this invention, the output voltage of the second stage regulator could also be modified in conjunction with the primary output voltage for maximum system optimization.

An implementation of the circuit of FIG. 1 may generate the following results, as verified through experimentation. In normal or high-power mode, the primary output voltage was 43V. In low-power mode, the primary output voltage was reduced to 26V. The input operated from an input voltage of 120-277V+/−10%. The secondary stage output voltage was fixed at a nominal 12.0V. When operated at full power, the 43V output was capable of 400 mA, and the 12V output was capable of 0.625 A for a total of 24.3 watts.

With a load of 0.025 A placed on the 12V output, or 300 mW, the low-power mode was enabled and disabled. Three runs were made at each setting. The results are presented in the table below for both 120V and 277V as the primary input voltage.

Enabling the low-power mode at 120V reduced the input power by a corrected 48.7 mW and increased the efficiency by 7.26% to 70.73%. At 277V, the reduction of input power was a corrected 49.0 mW and the increase in efficiency of 6.15% to 64.47%. The reductions in input power could help a product meet regulatory requirements and determine marketability.

| | | | | | | | | |
|---|---|---|---|---|---|---|---|---|
| Input AC | Input AC | Input AC | Corrected Power | Output DC | Output DC | Output DC | Efficiency | Efficiency |
| Voltage | Current | Power | Reduction | Voltage | Current | Power | in % | Improvement % |

Measurements with Primary Voltage at High Level

| | | | | | | |
|---|---|---|---|---|---|---|
| 277.74 | 0.0078 | 0.5207 | 12.0123 | 0.02527 | 0.3036 | 58.3122 |
| 120.21 | 0.0119 | 0.4783 | 12.0159 | 0.02526 | 0.3036 | 63.4669 |

Measurements with Primary Voltage at Low Level

| | | | | | | | | |
|---|---|---|---|---|---|---|---|---|
| 277.37 | 0.0076 | 0.4718 | 0.0490 | 12.0125 | 0.02532 | 0.3041 | 64.4882 | 6.1560 |
| 120.17 | 0.0109 | 0.4297 | 0.0437 | 12.0143 | 0.02529 | 0.3039 | 70.7307 | 7.2639 |

Implementation of these concepts is not limited to the arrangement of FIG. 1 and various electronic circuits for achieving the features described in this disclosure is within the knowledge and experimentation of those of ordinary skill in the art. For instance, while circuit 100 depicts primary feedback for flyback controller 108, where voltage is detected through transformer 105, secondary feedback is an alternative. In secondary feedback, circuitry on the output side with an optocoupler would provide voltage for the flyback controller 108 to regulate to.

Also, while circuit 100 shows control of a resistor network at the Reference pin of flyback controller 108, the resistor network could be associated with the Volt-Feedback pin of flyback controller 108 instead. This resistor network may include resistors 118 and 120 forming the voltage divider at the Volt-Feedback pin. In either situation, flyback controller 108 will adjust the output voltage based on the voltage at the respective input pin, which would be adjusted by turning on or off switch 128. The variations needed to the circuitry for these scenarios are within the knowledge of those of ordinary skill in the art.

Similarly, while the control of the resistor network on the Reference pin is shown using resistor 126 and switch 128, other circuit arrangements are readily available to those skilled in the art. Although switch 128 is shown as a MOSFET, an optocoupler or other kind of switch could alternatively be employed. In addition, an arrangement for selectively adjusting the monitored voltage at an input pin of flyback controller 108 other than with a resistor divider network and a switch may be employed and is within the knowledge of those skilled in the art. In whole, the option shown in FIG. 1 provides a simple and low-cost choice that enables improved functionality within minimal expense.

Although this subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A power supply, comprising:
a flyback converter comprising a transformer having a primary side and secondary side and a first switch coupled between the primary side of the transformer and ground;
a flyback controller having a control input coupled to at least a first resistor and an output coupled to the primary side of the transformer through the first switch;
a low-power-mode circuit comprising a second resistor connected in parallel with the first resistor and in series with a second switch, wherein the second switch is configured to activate a low-power mode of the power supply;
a first stage output coupled to the secondary side of the transformer for powering a first external circuit in a high-power mode of the power supply; and
a second stage output coupled to the secondary side of the transformer through a DC-DC converter for powering a second external circuit in at least the low-power mode of the power supply.

2. The power supply of claim 1, wherein the first resistor and the second resistor are part of a voltage divider selectively modified by the second switch.

3. The power supply of claim 1, wherein the second switch comprises an input alternatively indicative of the low-power mode or the high-power mode for the power supply.

4. The power supply of claim 1, wherein the low-power-mode circuit is configured to cause a voltage at the control input to change when the second switch is closed.

5. The power supply of claim 4, wherein the low-power-mode circuit is configured to cause an output voltage on the secondary side of the transformer to decrease and to remain above an operating voltage of the DC-DC controller when the second switch is closed.

6. The power supply of claim 5, wherein the output voltage on the secondary side of the transformer is decreased from about 40V to about 20-30V when the second switch is closed.

7. A power supply, comprising:
a flyback converter;
a flyback controller coupled to an input of the flyback converter, the flyback controller having a reference input and a feedback input;
a first voltage divider coupled to the reference input;
a second voltage divider coupled to the feedback input; and
a low-power-mode circuit configured to cause one of a first voltage at the reference input or the second voltage at the feedback input to change in response to a control signal indicating an operational change from a high-power mode to a low-power mode.

8. The power supply of claim 7, further comprising:
a first stage output coupled to an output of the flyback converter for providing a DC voltage to an external circuit in the high-power mode.

9. The power supply of claim 8, further comprising:
a second stage output coupled to the output of the flyback converter, the second stage output comprising a DC-DC controller converting the DC voltage to a lower DC voltage for powering a second external circuit in at least the low-power mode.

10. The power supply of claim 7, wherein causing one of the first voltage or the second voltage to change comprises modifying a respective one of the first voltage divider or the second voltage divider.

11. The power supply of claim 10, wherein the low-power-mode circuit comprises a resistor in series with a switch.

12. The power supply of claim 11, wherein the switch is configured to selectively add or remove the resistor with respect to one of the first voltage divider or the second voltage divider in response to the control signal.

13. The power supply of claim 7, wherein the resistor has a resistance sufficient to cause an output of the flyback converter to decrease from about 40V to about 20-30V when the switch is closed.

14. A method, comprising:
providing, within a flyback converter, a DC input voltage to a primary side of a transformer;
generating an output signal from a flyback controller at least in part in response to a voltage at an input pin of the flyback controller;
modifying a first flow of current through the primary side of the transformer at least in part in response to the output signal from the flyback controller;
directing a DC output voltage from a secondary side of the transformer to a first-stage load;
converting, with a DC-DC converter, the DC output voltage to a lower DC output voltage for a second-stage load;
receiving activation of a low-power-mode signal;
at least in part in response to the activation, causing the DC output voltage to decrease to a low-power-mode DC output voltage at least by changing the voltage at the input pin of the flyback controller while continuing to generate the output signal.

15. The method of claim 14, wherein changing the voltage at the input pin of the flyback controller comprises, in response to the activation, modifying a voltage divider coupled to the input pin.

16. The method of claim 15, wherein modifying a voltage divider comprises closing a switch to complete a circuit with a resistor coupled to the input pin.

17. The method of claim 14, wherein the DC-DC converter, using the low-power-mode DC output voltage, continues to provide the lower DC output voltage at a higher power efficiency.

18. The method of claim 17, wherein the DC output voltage is about 40V and the low-power-mode DC output voltage is about 20-30V.

19. The method of claim 14, further comprising:
receiving deactivation of the low-power-mode signal;
at least in part in response to the deactivation, changing the voltage at the input pin of the flyback controller, wherein the changing the voltage causes the low-power-mode DC output voltage to increase to the DC output voltage.

20. The method of claim 14, wherein changing the voltage at the input pin of the flyback controller comprises, in response to the deactivation, closing the switch to disconnect from ground the resistor coupled to the input pin.
